(19) United States
(12) Patent Application Publication
(10) Pub. No.: US 2021/0270511 A1
(43) Pub. Date: Sep. 2, 2021

(54) MOTOR DRIVING APPARATUS AND AIR CONDITIONER INCLUDING THE SAME

(71) Applicant: LG Electronics Inc., Seoul (KR)

(72) Inventors: Sunghwan KIM, Seoul (KR); Jeongeon OH, Seoul (KR); Yonghwa LEE, Seoul (KR); Songhee YANG, Seoul (KR)

(21) Appl. No.: 17/185,339

(22) Filed: Feb. 25, 2021

(30) Foreign Application Priority Data
Feb. 25, 2020 (KR) 10-2020-0023213

(51) Int. Cl. F25B 49/02; H02P 27/08

(52) U.S. Cl. CPC F25B 49/025; F25B 2600/021; H02P 27/085

(57) ABSTRACT

A motor driving apparatus includes: an inverter that includes a plurality of switching elements and that is configured to output AC power to a motor by a switching operation of the plurality of switching elements, a switching unit that includes a relay and that is configured to switch a connection mode of the motor by an operation of the relay, and an inverter controller configured to control the inverter and the switching unit. The inverter controller is configured to, based on the relay being turned off, apply a reverse voltage to the relay.

### CROSS-REFERENCE TO RELATED APPLICATION

This application claims the priority benefit of Korean Patent Application No. 10-2020-0023213, filed on Feb. 25, 2020 in the Korean Intellectual Property Office, the disclosure of which is incorporated herein by reference.

### BACKGROUND OF THE INVENTION

### 1. Field of the Invention

The present disclosure relates to a motor driving apparatus and air conditioner including the same, and more particularly, to a motor driving apparatus capable of switching the connection mode of a motor, and air conditioner including the same.

### 2. Description of the Related Art

A home appliance is a device used for user convenience. In addition, home appliances such as air conditioners, washing machines and refrigerators used in predetermined spaces such as homes and offices each perform unique functions and operations according to user manipulation.

An air conditioner is installed to provide a more comfortable indoor environment to humans, by adjusting the indoor temperature and purifying the indoor air, by discharging cold and hot air into the room to create a comfortable indoor environment. In general, the air conditioner includes an indoor unit configured as a heat exchanger and installed indoor, and an outdoor unit configured by a compressor and a heat exchanger to supply refrigerant to the indoor unit.

Meanwhile, a motor driving apparatus is a device for driving a motor having a rotor for rotating motion and a stator wound around a coil. In particular, the motor driving apparatus may be used to drive a motor in a home appliance.

In general, a motor for driving is used in a compressor of an air conditioner. A motor used in such a compressor may be operated in a general Wye (Y) connection method or may be designed to be operated in a delta (Δ) connection method. In this case, since the Δ connection method may increase the output voltage of the inverter, there is an advantage in that it is possible to operate at a higher speed more efficiently than when the Y connection method is operated.

Meanwhile, it may be designed to be usable in both the Y connection method and the Δ connection method. For example, Japanese Patent Publication No. 4619826 compares the number of revolutions of an electric motor with a threshold value, and when a state where the number of revolutions is greater or less than the threshold value has elapsed for a certain period of time, the Y connection is switched to the Δ connection.

It takes a certain amount of time to switch the connection of the motor, but the time required for switching may cause a decrease in driving efficiency of the motor. For example, the pressure applied to the compressor may be lost during the motor connection switching process. Accordingly, the efficiency of the air conditioner may be lowered when switching the motor connection.

### SUMMARY OF THE INVENTION

The present disclosure has been made in view of the above problems, and provides a motor driving apparatus capable of switching the connection mode of a motor at high speed, and air conditioner including the same.

The present disclosure further provides a motor driving apparatus capable of preventing a decrease in efficiency due to switching of a connection mode, and air conditioner including the same.

The present disclosure further provides a motor driving apparatus capable of minimizing output fluctuations of a motor by minimizing the speed that decreases during switching by reducing delay time of a relay, and air conditioner including the same.

The present disclosure further provides a motor driving apparatus capable of reducing power consumption when switching a connection mode, and air conditioner including the same.

A motor driving apparatus according to an embodiment of the present disclosure for achieving the above object, and an air conditioner including the same, switch a connection mode of a motor at higher speed by applying a reverse voltage when a relay is turned off.

A motor driving apparatus according to an embodiment of the present disclosure for achieving the above object, and an air conditioner including the same, switch a connection mode of a motor at higher speed by including an improved relay circuit.

An air conditioner according to an embodiment of the present disclosure for achieving the above object includes a motor and a motor driving apparatus. A motor driving apparatus according to an embodiment of the present disclosure for achieving the above object, comprises an inverter includes switching elements and configured to output AC power to a motor by a switching operation of the switching elements; a switching unit includes a relay and configured to switch a connection mode of the motor by an operation of the relay; and an inverter controller configured to control the inverter and the switching unit; wherein the inverter controller applies a reverse voltage when the relay is turned off.

Meanwhile, the inverter controller controls a sustain voltage after the relay on point to be lower than the on voltage at the relay on timing.

Meanwhile, the relay includes a coil configured to magnetize according to power supply, a holding resistor and a holding capacitor connected in parallel to the coil, a diode configured to have one end connected to the coil and the other end connected to the holding resistor and the holding capacitor.

In addition, the relay further includes a signal switch connected to the other end of the diode to supply or cut off power to the coil.

In addition, when the signal switch is turned on, constant current flows to the coil, and when the signal switch is turned off, the diode is conducted and a coil current flows from the coil to the diode.

In addition, the diode turns off as the coil current decreases and then becomes zero.

In addition, the inverter controller turns off the signal switch while a predetermined current flows through the coil, and controls the reverse voltage to be applied to the coil for a predetermined time.

In addition, the inverter controller controls time when the reverse voltage is applied shorter than the off time of the relay.

Meanwhile, when the coil voltage is on, the contact state is set to contact a point of the relay, and when the coil voltage is off, the contact state is set to the contact b point of the relay.

Meanwhile, the switching elements and the relay are arranged on different printed circuit board (PCB) boards.

Meanwhile, the inverter controller controls to stop the PWM (Pulse Width Modulation) control according to the switching of the connection mode, to estimate the rotational state of the rotor rotating inertia, and when the PWM control resumes, to set the estimated rotational state of the rotor as the initial value of the rotor, and the rotation speed of the motor in which the connection mode is switched based on the set initial value of the rotor.

A motor driving apparatus according to an embodiment of the present disclosure for achieving the above object, and an air conditioner including the same, comprise an inverter includes switching elements and configured to output AC power to a motor by a switching operation of the switching elements; and a switching unit includes a relay and configured to switch a connection mode of the motor by an operation of the relay; and wherein the relay includes a coil configured to magnetize according to power supply, a holding resistor and a holding capacitor connected in parallel to the coil, a diode configured to have one end connected to the coil and the other end connected to the holding resistor and the holding capacitor.

Meanwhile, the relay further includes a signal switch connected to the other end of the diode to supply or cut off power to the coil.

In addition, when the signal switch is turned on, constant current flows to the coil, and when the signal switch is turned off, the diode is conducted and a coil current flows from the coil to the diode.

In addition, the diode turns off as the coil current decreases and then becomes zero.

Meanwhile, when the coil voltage is on, the contact state is set to contact a point of the relay, and when the coil voltage is off, the contact state is set to the contact b point of the relay.

Meanwhile, the switching elements and the relay are arranged on different printed circuit board (PCB) boards.

Meanwhile, a motor driving apparatus according to an embodiment of the present disclosure for achieving the above object, and an air conditioner including the same, further comprise a controller configured to control the switching unit.

Meanwhile, a motor driving apparatus according to an embodiment of the present disclosure for achieving the above object, and an air conditioner including the same, further comprise further comprise an inverter controller configured to control the inverter and the switching unit.

An air conditioner according to an embodiment of the present disclosure for achieving the above object, comprises an inverter includes switching elements and configured to output AC power to a motor by a switching operation of the switching elements; and a switching unit includes a relay and configured to switch a connection mode of the motor by an operation of the relay; and wherein the relay includes a coil configured to magnetize according to power supply, a holding resistor and a holding capacitor connected in parallel to the coil, a diode configured to have one end connected to the coil and the other end connected to the holding resistor and the holding capacitor.

### BRIEF DESCRIPTION OF THE DRAWINGS

The above and other objects, features and advantages of the present disclosure will be more apparent from the following detailed description in conjunction with the accompanying drawings, in which:

FIG. 1 is a diagram illustrating a configuration of an air conditioner according to an embodiment of the present disclosure;

FIG. 2 is a schematic diagram of an outdoor unit and an indoor unit of FIG. 1;

FIG. 3 is a simplified internal block diagram of the air conditioner of FIG. 1;

FIG. 4 is an internal block diagram of a motor driving apparatus according to an embodiment of the present disclosure;

FIG. 5 is an exemplary diagram showing an arrangement of a printed circuit board of a motor driving apparatus according to an embodiment of the present disclosure;

FIGS. 6A and 6B are exemplary diagrams illustrating an example of the connection modes of the motor according to embodiment of the present disclosure;

FIG. 7 is a diagram illustrating a relay structure according to an embodiment of the present disclosure;

FIGS. 8A and 8B are internal block diagrams of a motor driving apparatus according to an embodiment of the present disclosure;

FIG. 9 illustrates an example of a relay operation waveform.

FIG. 10 is a diagram illustrating a relay operation waveform according to an embodiment of the present disclosure;

FIGS. 11A and 11B are diagrams illustrating an example of a conventional relay circuit and an operation waveform;

FIG. 12 is a diagram illustrating an example of a relay circuit according to an embodiment of the present disclosure;

FIG. 13 is a diagram illustrating an example of an operation waveform of a relay circuit according to an embodiment of the present disclosure;

FIG. 14 is an enlarged view illustrating a part of an operation waveform of a relay circuit according to an embodiment of the present disclosure;

FIGS. 15A to 15C are diagrams illustrating current paths corresponding to the operation waveform section of FIG. 14;

FIGS. 16A and 16B are diagrams illustrating a relay circuit current path and an equivalent circuit in a reverse voltage section according to an embodiment of the present disclosure;

### DETAILED DESCRIPTION OF THE PREFERRED EMBODIMENTS

Hereinafter, the present disclosure will be described in detail with reference to the accompanying drawings. In order to clearly and briefly describe the present disclosure, components that are irrelevant to the description will be omitted in the drawings. The same reference numerals are used throughout the drawings to designate the same or similar components. Terms “module” and “part” for elements used in the following description are given simply in view of the ease of the description, and do not carry any important meaning or role. Therefore, the “module” and the “part” may be used interchangeably. It will be understood that, although the terms “first”, “second”, etc. may be used herein to describe various elements, these elements should not be limited by these terms. These terms are only used to distinguish one element from another element.

Meanwhile, a motor driving apparatus described in the present specification may be a motor driving apparatus provided in a home appliance. The home appliance includes a refrigerator, a washing machine, a dryer, an air conditioner, a dehumidifier, a cooking appliance, a vacuum cleaner, and the like. Hereinafter, an air conditioner among various home appliances will be mainly described.

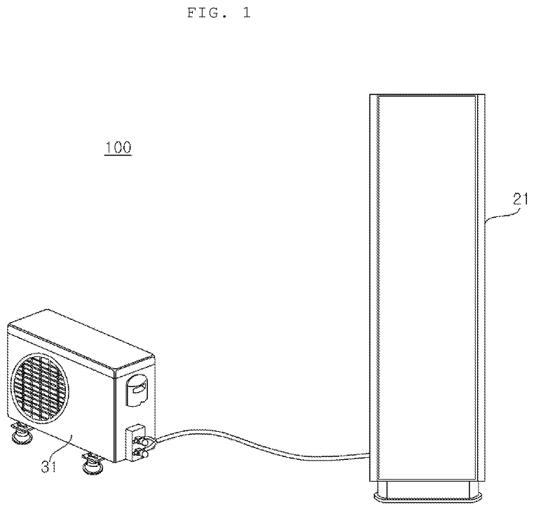

FIG. 1 is a diagram illustrating a configuration of an air conditioner according to an embodiment of the present disclosure.

Referring to FIG. 1, an air conditioner 100 according to the present disclosure may include an indoor unit 21, and an outdoor unit 31 connected to the indoor unit 21.

The indoor unit 21 of the air conditioner is applicable to any of a stand type air conditioner, a wall-mounted type air conditioner, and a ceiling type air conditioner, but in the drawing, a stand type indoor unit 21 is illustrated.

Meanwhile, the air conditioner 100 may further include at least one of a ventilation device, an air cleaning device, a humidifying device, and a heater, and may operate in conjunction with the operation of the indoor unit and the outdoor unit.

The outdoor unit 31 includes a compressor (not shown) that receives and compresses a refrigerant, an outdoor heat exchanger (not shown) that heat exchanges the refrigerant with an outdoor air, an accumulator (not shown) that extracts gaseous refrigerant from the supplied refrigerant and supplies the gaseous refrigerant to the compressor, and a four-way valve (not shown) that selects a flow path of the refrigerant according to the heating operation. In addition, a plurality of sensors, a valve, an oil collector, and the like are further included, but a description of their configuration will be omitted below.

The outdoor unit 31 operates the provided compressor and outdoor heat exchanger and compresses or heat exchanges the refrigerant according to a setting to supply the refrigerant to the indoor unit 21. The outdoor unit 31 may be driven by a remote controller (not shown) or a demand of the indoor unit 21. In this case, as the cooling/heating capacity is varied in correspondence with the driven indoor unit, the number of operation of the outdoor unit and the number of operation of the compressor installed in the outdoor unit may be varied. In addition, although FIG. 1 shows a single indoor unit 21 and a single outdoor unit 31, the present disclosure is not limited thereto. For example, several indoor units 21 may be connected to a single outdoor unit 31 through a refrigerant pipe.

At this time, the outdoor unit 31 supplies the compressed refrigerant to the connected indoor unit 21.

The indoor unit 21 receives a refrigerant from the outdoor unit 31 and discharges cold and hot air into the room. The indoor unit 21 includes an indoor heat exchanger (not shown), an indoor unit fan (not shown), an expansion valve (not shown) through which the supplied refrigerant is expanded, and a plurality of sensors (not shown).

At this time, the outdoor unit 31 and the indoor unit 21 are connected by wire or wireless to transmit and receive data, and the outdoor unit and the indoor unit are connected to a remote controller (not shown) by wire or wirelessly to operate according to the control of the remote controller (not shown).

The remote controller (not shown) may be connected to the indoor unit 21, input a user's control command to the indoor unit, and receive and display state information of the indoor unit. In this case, the remote controller may communicate by wire or wirelessly according to a connection type with the indoor unit.

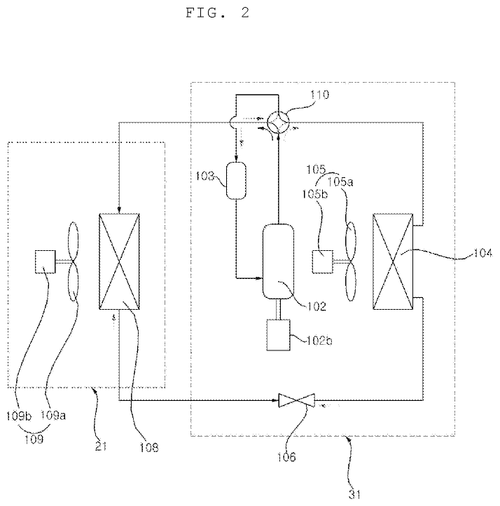

FIG. 2 is a schematic diagram of an outdoor unit and an indoor unit of FIG. 1.

Referring to FIG. 2, the air conditioner 100 is largely divided into an indoor unit 21 and an outdoor unit 31.

The outdoor unit 31 may include a compressor 102 that serves to compress a refrigerant, a compressor motor 102b that drives the compressor, an outdoor heat exchanger 104 that serves to dissipate heat of the compressed refrigerant, an outdoor blower 105 comprising an outdoor fan 105a that is disposed in one side of the outdoor heat exchanger 104 and promotes heat dissipation of refrigerant and a motor 105b that rotates the outdoor fan 105a, an expansion mechanism or expansion valve 106 that expands the condensed refrigerant, a cooling/heating switching valve or four-way valve 110 that changes the flow path of the compressed refrigerant, and an accumulator 103 that temporarily stores the gasified refrigerant to remove moisture and foreign matter, and then supplies a refrigerant of constant pressure to the compressor.

The indoor unit 21 includes an indoor heat exchanger 108 disposed indoors to perform a cooling/heating function, an indoor blower 109 comprising an indoor fan 109a disposed in one side of the indoor heat exchanger 108 to promote heat dissipation of refrigerant and an electric motor 109b rotating the indoor fan 109a, and the like.

At least one indoor heat exchanger 108 may be installed. At least one of an inverter compressor and a constant speed compressor may be used as the compressor 102.

In addition, the air conditioner 100 may be configured of a cooler that cools the room, or may be configured of a heat pump that cools or heats the room.

Meanwhile, the outdoor fan 105a in the outdoor unit 31 may be driven by an outdoor fan driving unit (not shown) that drives the motor 105b.

Meanwhile, the compressor 102 in the outdoor unit 31 may be driven by a compressor motor driving unit (not shown) that drives a compressor motor 102b.

Meanwhile, the indoor fan 109a in the indoor unit 21 may be driven by an indoor fan driving unit (not shown) that drives an indoor fan motor 109b.

The outdoor fan driving unit may be referred to as an outdoor fan driving device. In addition, the indoor fan driving unit may be referred to as an indoor fan driving device.

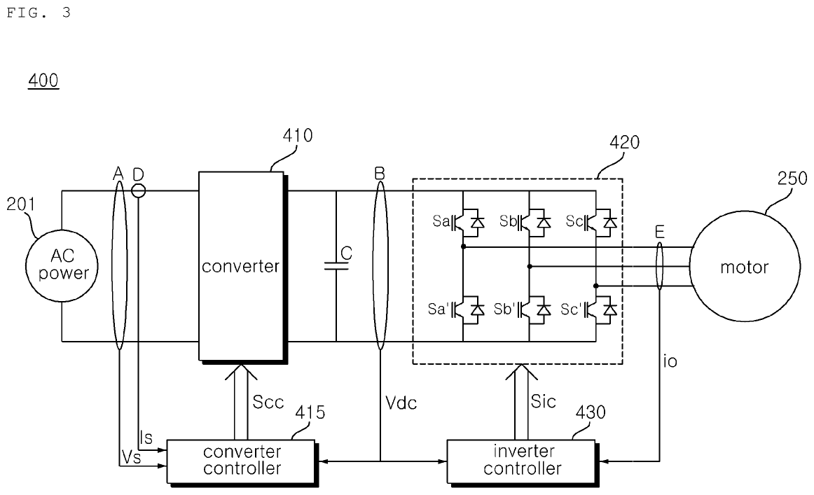

FIG. 3 is a simplified internal block diagram of the air conditioner of FIG. 1, and FIG. 4 is an internal block diagram of a motor driving apparatus according to an embodiment of the present disclosure.

Referring to the FIG. 3 and FIG. 4, the motor driving apparatus 400 according to an embodiment serves to drive the motor 250, and includes an inverter 420 and an inverter controller 430.

Referring to the FIG. 3 and FIG. 4, the motor driving apparatus 400 according to an embodiment may include a converter 410 to convert an input power 201 to a direct current (DC) and output the converted DC power to a DC terminal, a converter controller 415, a capacitor C connected to the DC terminal, an inverter 420 that includes a plurality of switching elements and converts the direct current (DC) power from the capacitor C to an alternating current (AC) power and an inverter controller 430 to control the inverter 420.

The motor driving apparatus 400 may further include an input voltage detector A, a DC link voltage detector B, an input current detector D, and an output current detector E.

Meanwhile, in FIG. 3 and more, a case in which the motor driving apparatus 400 converts power input from the commercial AC power 201 and supplies it to the motor 250 is illustrated. In this case, the motor driving motor driving apparatus 400 may be referred to as a motor driving unit or the like. Alternatively, the motor driving motor driving apparatus 400 may convert input power and supply it to a load. In this case, the motor driving apparatus 400 may be referred to as a power converting device or the like.

The converter 410 converts the commercial AC power 201 into DC power and outputs the DC power. To this end, the converter 410 may include a rectifying unit. In addition, it is also possible to further include a reactor.

A smoothing capacitor C is connected to the output terminal of the converter 410. The capacitor C may store power output from the converter 410. Since the power output from the converter 410 is a dc power, it may be referred to as a dc link capacitor.

The inverter 420 may output the converted AC power to the motor 250.

Referring to the FIG. 3, The input voltage detector A may detect an input voltage Vs from the input AC power 201.

The input voltage detector A may detect an input voltage is input from the commercial AC power source 201. To this end, a resistance element, an OP AMP, or the like may be used as the input current detector D. The detected input current may be input to the inverter controller 430 as a discrete signal in the form of a pulse.

Meanwhile, a zero crossing point of the input voltage may also be detected by the input voltage detector A.

The input current detector D may detect an input current is input from the commercial AC power source 201. To this end, a current transformer (CT), a shunt resistor, or the like may be used as the input current detector D. The detected input current may be input to the inverter controller 430 as a discrete signal in the form of a pulse for calculating power consumption.

Next, a capacitor C may be provided at the output terminal of the converter 410 to store or smooth the power converted by the converter 410. At this time, both ends of the capacitor (C) may be referred to as a dc link. Therefore, the capacitor C may be referred to as a dc link capacitor.

Meanwhile, the converter controller 415 may generate a converter switching control signal Scc based on the input voltage Vs, the input current Is, and the dc link voltage Vdc, and output it to the converter 410.

The DC link voltage detector B may detect the DC link voltage Vdc between both ends of the smoothing capacitor C. To this end, the DC link voltage detector B may include a resistance element and an amplifier. The detected DC link voltage Vdc may be input to the inverter controller 430 as a discrete signal in the form of a pulse.

The inverter 420 may drive the motor 250. To this end, the inverter 420 may include a plurality of inverter switching devices, and may convert the smoothed DC power Vdc into 3-phase AC powers having predetermined frequencies by the on/off operation of the switching device, and output the same to a 3-phase synchronous motor 250.

The inverter 420 includes upper switching devices Sa, Sb and Sc and lower switching devices S′a, S′b and S′c, wherein each of the upper switching devices Sa, Sb, Sc and a corresponding lower switching device S′a, S′b, S′c are connected in series to form a pair and three pairs of upper and lower switching devices Sa and S′a, Sb and S′b, and Sc and S′c are connected in parallel. Each of the switching devices Sa, S′a, Sb, S′b, Sc and S′c is connected with a diode in anti-parallel.

Each of the switching devices in the inverter 420 is turned on/off based on an inverter switching control signal Sic from the inverter controller 430. Thereby, 3-phase AC power having a predetermined frequency is output to the 3-phase synchronous motor 250.

The inverter controller 430 may control the switching operation of the inverter. To this end, the inverter controller 430 may receive an output current io detected by the output current detector E.

In order to control the switching operation of the inverter 420, the inverter controller 430 outputs the inverter switching control signal Sic to the inverter 420. The inverter switching control signal Sic is a pulse width modulated (PWM) switching control signal. The inverter switching control signal Sic is generated and output based on the output current io detected by the output current detector E. The inverter controller 430 may control switching elements in the inverter 420 by variable control of a pulse width (PWM) based on a space vector.

The output current detector E may detect the output current io flowing between the inverter 420 and the 3-phase motor 250. That is, the output current detector E may detect an current flowing to the motor 250. The output current detector E may detect all of the output currents ia, ib, and is of each phase, or may detect the output currents of two phases using three-phase equilibrium.

The output current detection unit E may be located between the inverter 420 and the motor 250, and a current transformer (CT), a shunt resistor, or the like may be used for current detection.

When a shunt resistor is used, three shunt resistors may be positioned between the inverter 420 and the synchronous motor 250, or one end may be connected to the three lower switching elements of the inverter 420, respectively. On the other hand, it is also possible to use two shunt resistors using three-phase equilibrium. Meanwhile, when one shunt resistor is used, a corresponding shunt resistor may be disposed between the capacitor C and the inverter 420 described above.

The detected output current io, which is a discrete signal in the form of a pulse, may be applied to the inverter controller 430, and the inverter switching control signal Sic is generated based on the detected output current io.

Meanwhile, the motor 250 may be the 3-phase motor. The 3-phase motor 250 includes a stator and a rotor, and the rotor rotates when the AC power of each phase of a predetermined frequency is applied to the coil of a corresponding phase (of phases a, b and c) of the stator.

As the type of the motor 250, various types such as a brushless direct current motor (BLDC motor), a synchronous motor, and an induction motor are possible. For example, a Surface-Mounted Permanent-Magnet Synchronous Motor (SMPMSM), an Interior Permanent Magnet Synchronous Motor (IPMSM), and a Synchronous Reluctance Motor (SynRM). The SMPMSM and the IPMSM are Permanent Magnet Synchronous Motors (PMSM) employing permanent magnets, while the SynRM does not have a permanent magnet.

The load 251 is for performing an operation implemented in the home appliance, and may be configured differently for each home appliance.

For example, when the clothes dryer includes the motor driving apparatus 400, the load 251 may be a blowing fan for supplying compressed air.

As another example, when the air conditioner includes the motor driving apparatus 400, the load 251 may be an indoor fan, an outdoor fan, or a compressor that compresses a refrigerant.

As another example, when the refrigerator includes the motor driving apparatus 400, the load 251 may be a refrigerating compartment fan or a freezing compartment fan.

As another example, the motor driving apparatus 400 of the present invention is for driving a compressor in a home appliance, and the load 251 of FIG. 4 may be a compressor that compresses a refrigerant.

The motor 250 may include a synchronous motor that operates in synchronization with a phase with an AC current having a sine wave shape, and an asynchronous motor that operates in a state that is not synchronized with the phase. Here, the synchronous motor may mean a motor that rotates in synchronization with the rotation of the rotating magnetic field and the rotor of the motor 250, and the asynchronous motor may mean a motor in which the rotation of the rotating magnetic field and the synchronization of the rotor of the motor 250 do not match.

In addition, the motor 250 may be formed to use both a Wye (Y) connection method and a Delta (A) connection method by different internal connection methods. In addition, the motor 250 may be a motor formed to enable switching of the connection mode during operation, and may include a switching unit 440 for switching the connection mode of the motor 250 for this purpose.

The switching unit 440 may include at least one switch to selectively connect windings according to different connection modes, and allow the windings according to a specific connection mode to be connected to each other. According to it, the motor 250 may be driven in any one of an operation mode according to a Y (Wye) connection method (hereinafter, Y connection mode) or an operation mode according to a Δ (Delta) connection method (hereinafter, Δ connection mode).

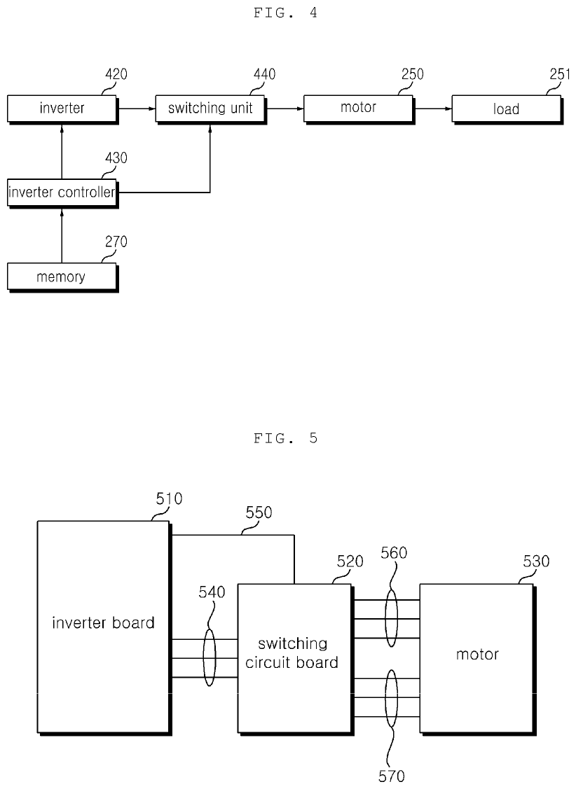

FIG. 5 is an exemplary diagram showing an arrangement of a printed circuit board of a motor driving apparatus according to an embodiment of the present disclosure.

Referring to FIG. 4 and FIG. 5, the switching unit 440 includes one or more switches, and the switching unit 440 for switching the connection mode of the motor 250 by the operation of a switch is a switching circuit board 520 may be placed on. Here, the switch provided in the switching unit 440 may be a relay.

In addition, an inverter 420 including switching elements and outputting AC power to the motor 250 by a switching operation may be disposed on the inverter board 510.

The inverter board 510 and the switching circuit board 520 may be connected to a three-phase output line 540 and a control signal line 550.

The output of the inverter 420 is output to the switching circuit board 520 through the three-phase output line 540. The three-phase AC power of the inverter 420 is output to the three-phase synchronous motor 530 via the switching circuit board 520.

The control signal line 550 may include a signal line (not shown) through which an operation signal for operating the relay is transmitted from the inverter board 510 to the switching circuit board 520.

In some cases, the inverter controller 430 may also be disposed on the inverter board 510. The relay operation signal of the inverter controller 430 may be transmitted to the switching circuit board 520 through the control signal line 550. Even when the inverter controller 430 is disposed outside the inverter board 510, the relay operation signal of the inverter controller 430 may be transmitted to the switching circuit board 520 through the inverter board 510 and the control signal line 550.

Meanwhile, the control signal line 550 may further include a power supply line and a ground (GND) line.

Meanwhile, the switching circuit board 520 and the motor 510 may be connected by a Y connection 560 and a delta connection 570, and the Y connection 560 and the delta connection 570 may be selected according to the relay operation in the switching circuit board 520.

When an inverter and a relay circuit are provided on a single printed circuit board (PCB), there is a problem in that it is not possible to detect a control signal line defect and a relay defect, and compatibility is poor.

However, according to an embodiment of the present invention, it is possible to distinguish and detect which parts are defective, and it is possible to minimize the effect of a component's operation and abnormal conditions on other components by disposing the inverter board 510 and the switching circuit board 520 on different printed circuit boards (PCBs).

According to an embodiment of the present invention, there is an advantage in common use by separately providing a switching circuit board 520 on which components of the switching unit 440 are mounted. For example, a conventional compressor and a winding switch type compressor may be shared and used.

The switching unit 440 may switch the connection mode according to the control of the inverter controller 430. According to an embodiment, a home appliance such as an air conditioner or a motor driving apparatus may include a separate controller (not shown) for controlling switching of a connection mode. Hereinafter, the switching unit 440 will be described focusing on an embodiment of switching the connection mode under the control of the inverter controller 430.

Meanwhile, when the connection mode is switched, the at least one switch is switched from the winding according to the connection mode before switching to the winding according to the connection mode after switching, so that the output of the inverter and the motor torque according to the switching may be blocked.

Meanwhile, when the output of the inverter 420 and the motor torque are blocked as the connection mode of the motor 250 is switched, the rotor of the motor 250 may be rotated inertia for a predetermined time until the moment of inertia becomes smaller than the load torque. When the rotor of the motor 250 rotates inertia, the inverter controller 430 may detect the state of the rotor rotates inertia. Here, the rotational state of the motor 250 may include different values detected from the inertial rotating rotor. For example, the rotational state of the rotor may include the rotation speed of the rotor during inertia rotation, or may include a position of a specific pole (eg, N pole) of the rotor during inertia rotation.

Meanwhile, when the state of the rotor rotating inertia is detected, the inverter controller 430 may set an initial value of the rotor according to the detected state of the rotor. For example, if the motor 250 is an asynchronous motor, the inverter controller 430 may set the detected rotation speed of the rotor as the initial value. On the other hand, if the motor 250 is a synchronous motor, the inverter controller 430 may set not only the rotation speed of the rotor but also the position of the specific pole of the rotor as an initial value.

And, the inverter controller 430 may control the speed of the motor 250 according to the switched connection mode based on the detected initial value. For example, the inverter controller 430 may control the motor 250 to synchronize the rotation of the rotating magnetic field and the rotation of the rotor based on the position of a specific pole included in the detected initial value of the rotor. And the inverter controller 430 may control the rotation speed of the motor 250, that is, the rotation speed of the rotor, so as to reach a speed according to the speed command frequency based on the rotation speed included in the detected initial value of the rotor. Accordingly, when the connection mode of the motor 250 is switched, the motor driving apparatus 400 according to an embodiment of the present invention may switch the connection mode at high speed by performing a motor control according to the connection mode in which the rotational state of the rotor rotating inertia is converted to an initial value. Accordingly, motor driving efficiency may be improved. For example, when the compressor is driven by a motor, it is possible to minimize the pressure of the compressor that is lost due to the switching.

Meanwhile, a memory 270 stores data required for control of the motor driving apparatus 400. The memory 270 may store information according to a current connection mode of the motor 250, and data and commands for controlling the motor 250 by the inverter controller 430 according to the current connection mode. In addition, the memory 270 may store data or commands for detecting the rotational state of the rotor during inertia rotation.

The inverter controller 430 may switch the connection mode by controlling the switching unit 440. In this case, the output of the inverter 420 applied to the motor 250 and the motor torque may be temporarily cut off due to the opening of the switch inside the switching unit 440. In addition, after a predetermined period of time, the output of the inverter 420 according to the switched connection mode is applied to the motor 250 to generate a motor torque.

Meanwhile, when the output of the inverter 420 applied to the motor 250 and the motor torque are temporarily blocked as the switching of the connection mode is performed, the rotor of the motor 250 may be in an inertial rotational state. Then, the inverter controller 430 may estimate the rotational state of the rotor of the inertial rotating motor 250 during a switching time according to the hardware characteristics of the switch of the switching unit 440.

In order to estimate the inertia rotational state of the rotor, the inverter controller 430 may use various methods. As an example, the inverter controller 430 uses a method of estimating the speed of and the position of the specific pole using the feature that the current induced in the rotor varies according to the position of the rotor when a zero voltage vector that makes the output voltage zero is applied to the inverter. Alternatively, the inverter controller 430 may use a method of generating an inertial rotation model of the rotor and estimating the rotation speed of the rotor and the position of a specific rotor pole based on the generated inertial rotation model.

Meanwhile, when the rotational state of the rotor during inertia rotation is estimated, the inverter controller 430 may set an initial value of the rotor based on the estimated state. For example, the estimated state of the rotor may include at least one of a rotation speed of the rotor and a position of a specific pole (eg, N pole). Accordingly, the inverter controller 430 may set at least one of the rotation speed of the rotor and the position of the N pole as an initial value.

In this case, if the motor 250 is an asynchronous motor that does not require synchronization between a rotating magnetic field and a rotor, the inverter controller 430 may set only the rotation speed of the rotor as the initial value of the rotor. On the other hand, if the motor 250 is a synchronous motor, the inverter controller 430 may set the rotation speed and the detected position of the N pole as an initial value of the rotor. This is because the synchronous motor requires synchronization of the rotating magnetic field and the rotor, and for this purpose, the rotating magnetic field may be synchronized according to the position of the N pole of the rotor.

When the initial value of the rotor is set, the inverter controller 430 may control the motor that is switched to the connection mode in which the connection mode is switched based on the set initial value. Accordingly, the output of the inverter according to the switched connection mode is applied to the motor 250 to generate motor torque again. That is, in the present invention, the output of the inverter (output according to the switched connection mode) may be applied to the motor 250 according to the rotational state of the rotor during inertia rotation while the rotor is in inertia rotation.

The inverter controller 430 allows the rotor to further accelerate (when switching from the Y connection mode to the Δ connection mode) or decelerate (When switching from Δ connection mode to Y connection mode) based on the current rotation speed of the rotor and the rotation speed of the motor 250 according to the speed command frequency. In this case, the inverter controller 430 may control the motor 250 so that the rotor is further accelerated or decelerated by a difference between the rotation speed of the motor 250 according to the speed command frequency and the rotation speed of the rotor set as an initial value.

And, the inverter controller 430 may detect whether the rotation speed of the rotor has reached a speed corresponding to the changed speed command frequency. And, when the rotation speed of the rotor reaches a speed corresponding to the changed speed command frequency, the process of switching the connection mode of the rotor according to the changed speed command frequency may be terminated.

Meanwhile, the process of setting the initial value of the rotor may further include a process of maintaining a rotational state of the currently detected rotor for a predetermined time. The purpose of this is to limit the occurrence of transient response output by maintaining the rotation speed according to the detected initial value of the rotor for a predetermined period, and to stabilize the rotation state of the rotor in the inertial rotation state to the output of the inverter and a rotation according to the motor torque.

When the output of the inverter 420 applied to the motor 250 and the motor torque are temporarily cut off as the switching of the connection mode is performed, the inverter controller 430 may model the inertia rotational state of the rotor to estimate the rotational state of the rotor in the inertial rotational state. For example, the inertial rotational state of the rotor may be modeled as shown in Equations 1 and 2 below.

$$\begin{matrix}{T}_{e} {\to }^{+} {◯}_{{-}_{{T}_{L}} ↑} {\to }_{{T}_{D}} \frac{1}{{J}_{m} s + {B}_{m}} \to {ω}_{rm} & [ Equation 1 ] \\ {T}_{e} - {T}_{L} = {J}_{m} \frac{d {ω}_{rm}}{dt} + {B}_{m} {ω}_{rm} \to d {ω}_{rm} = - {T}_{L} \text{/} {J}_{m} dt & [ Equation 2 ]\end{matrix}$$

Here, Te is the electric torque, which is the magnitude of the torque induced by the rotor, IL is the magnitude of the load torque, ID is the difference between the electric torque and the load torque, Jm is the inertia of the rotor, S is the Laplace constant, Bm is It means the coefficient of friction, and ωᵣₘ is the angular velocity of the rotor.

Here, as described above, Te may be 0 because the output of the inverter is blocked and the rotor rotates inertia. In addition, the coefficient of friction (Bm) may be assumed to be zero by considering it as the load torque (TL). Meanwhile, when the motor is a compressor driving motor, the load torque TL may be a compression load of the compressor.

Meanwhile, the inverter controller 430 may estimate the rotational state of the rotor according to the time elapsed from the time when the motor torque is cut off, that is, the time when the output of the inverter is cut off according to the inertial rotation model shown in Equations 1 and 2.

For example, the inverter controller 430 may calculate the angular speed of the rotor according to the inertial rotation model, and may estimate the calculated angular speed as a rotation speed according to the inertia rotation of the rotor. In addition, when the motor 250 is a synchronous motor, the position of the N pole of the rotor may be further estimated based on the calculated angular speed. Then, the inverter controller 430 may set the estimated rotation speed of the rotor as the initial speed of the rotor. In addition, when the motor 250 is a synchronous motor, a process of setting the estimated position of the N pole of the rotor as the initial position of the rotor may be further performed.

Meanwhile, the above-described method has been described as an example of a method of estimating a rotational state of a rotor during inertia rotation in the present invention, and the present invention is not limited thereto. For example, it is possible to correct the position of the rotor by reflecting the phase difference according to the switching of the connection mode.

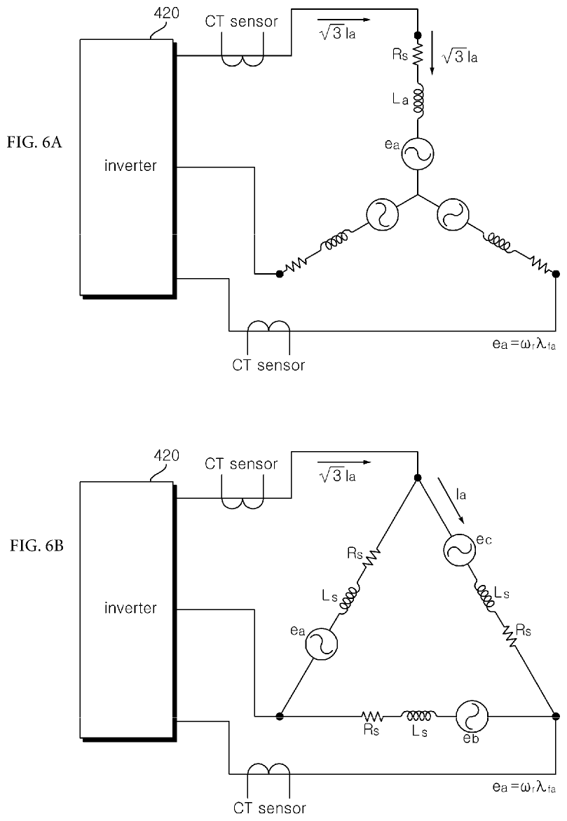

FIG. 6 is an exemplary diagram illustrating an example of the connection modes of the motor according to embodiment of the present disclosure. FIG. 6 of FIG. 6 illustrates an example of a state in which the windings are connected in the Y connection mode, and FIG. 6 illustrates an example of a state in which the windings are connected in the Δ connection mode.

First, referring to FIG. 6A, when the windings are connected in the Y connection mode, since current is applied to the windings forming the Y connection structure, the current (\sqrt{3}Ia) as the output current \sqrt{3}Ia of the inverter 420 may flow in. In this case, the magnetic flux interlinkage, inductance, and winding resistance are respectively may be λf. Ld, q, Rs.

On the other hand, referring to FIG. 6B, when the windings are connected in the Δ connection mode, the current flows into the windings forming the Δ connection structure, so there is a phase difference of 30 degrees from the direction in which the windings are connected in the Y connection structure. In addition, the current \sqrt{3}Ia reduced to 1/\sqrt{3} relative to the output current Ia of the inverter 420 may flow into the windings according to the phase difference. And the magnetic flux interlinkage may be reduced to 1/\sqrt{3}, and inductance and winding resistance may be reduced to ⅓, respectively. Table 1 shows the difference between the magnetic flux interlinkage, the inductance, and the winding resistance according to the structural difference in the connection mode.

Meanwhile, a phase difference of 30 degrees occurs according to the structural characteristics in which the windings are connected in the case of the Δ connection mode, so when the inverter controller 430 is switched from the Y connection mode to the Δ connection mode, the inverter controller 430 may perform accurate motor control according to the Δ connection mode by changing determines the position of the rotor to +30 degrees. On the other hand, when switching from the Δ connection mode to the Y connection mode, the position of the rotor must be changed by −30 degrees to perform accurate motor control according to the Y connection mode. Therefore, the position of the rotor may be corrected by reflecting the phase difference caused by switching the connection mode.

TABLE 1

| Motor | magnetic flux | Inductance | winding |
|---|---|---|---|
| Connection | interlinkage (λ_{f}) | (L_{d, q}) | resistance (Rₛ) |
| Υ (Wye) | λ_{f} | L_{d, q} | Rₛ |
| Δ (Delta) | λ_{f}/\sqrt{3} | L_{d, q}/3 | Rₛ/3 |

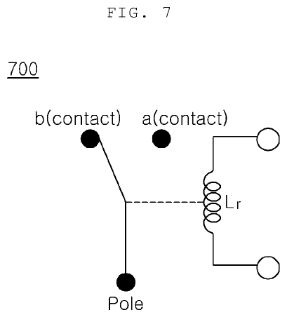

FIG. 7 is a diagram illustrating a relay structure according to an embodiment of the present disclosure, shows an example of a relay that the switching unit 440 may include.

Referring to FIG. 7, the relay 700 may include one pole and two contacts (contact a and contact b). In addition, the relay 700 may include an electromagnet coil Lr.

The contact b (Y winding) may be a basic state that is maintained by a basic spring of a mechanical relay switch. When a current is applied to the coil Lr, it becomes magnetized. Using the magnetism, an iron plate may be attached or floated, and the contact state may be changed. For example, when the coil voltage is turned on, the coil Lr moves to the contact a by the force of the electromagnet, and when the coil voltage is turned off, the coil voltage may move to the contact b by the spring force.

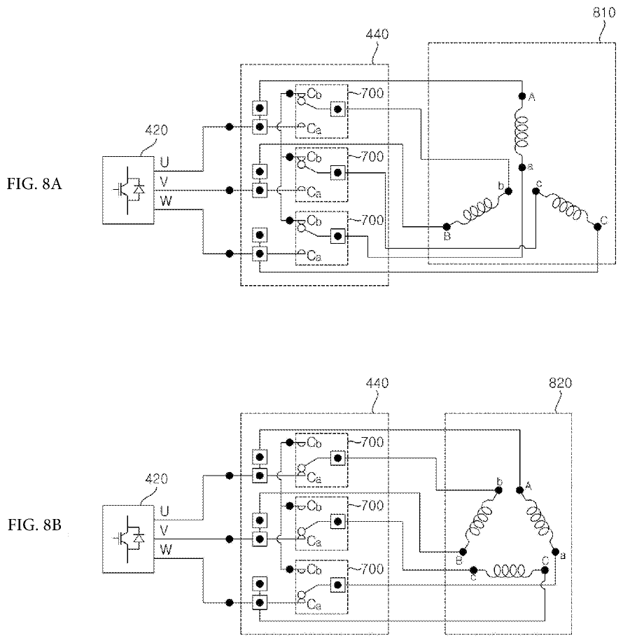

FIG. 8 is an internal block diagram of a motor driving apparatus according to an embodiment of the present disclosure, and FIG. 8 illustrates connection modes using the relay 700 of FIG. 7.

Referring to FIG. 8A, when the coil voltage is turned on (ON), the contact state of the relay 700 moves to the contact a (Ca) by the coil Lr electromagnet force, and a connection mode may be switched to the Y connection mode 810. Accordingly, the three-phase outputs (U, V, W) of the inverter 420 may be applied to the motor 250 of the Y connection mode 810 through the contact a (Ca) of the relay 700.

Referring to FIG. 8B, when the coil voltage is off (OFF), the contact state of the relay 700 is moved to the contact b (Cb) by a spring force, a connection mode may be switched to the Δ connection mode 820. Accordingly, the three-phase outputs U, V, and W of the inverter 420 may be applied to the motor 250 of the Δ connection mode 820 through the contact b Cb of the relay 700.

In the case of the winding switching motor 250, the lead lines U, V, and W for each phase of the three-phase motor 250 may be connected to the inverter 420 through the relay 700 of the switching unit 440.

When driving at a low speed, the motor 250 is connected in a Y shape as shown in FIG. 8A, and may have a high back EMF and may have a low speed high torque characteristic. In addition, when driving at high speed, the motor 250 is connected in a Δ shape as shown in FIG. 8B, and may have a low back EMF characteristic and a high-speed operation area is possible. Accordingly, more efficient operation is possible by switching the connection mode according to the target speed and load of the motor 250.

FIG. 9 illustrates an example of a relay operation waveform.

In FIG. 9, the operating time is an on time excluding chattering in which opening and closing are repeated when the state of switching is changed, and the release time is off time excluding chattering.

The connection modes 810 and 820 of the motor 250 are converted according to the state of the relay 700. On the other hand, since the relay 700 operates based on mechanical movement, it has a conversion time of about tens of ms. In addition, it takes time for the coil Lr to become magnetic.

During this conversion time, the motor windings are in a transient state, and thus PWM control may be stopped during connection mode switching. On the other hand, fluctuations in the speed and output of the motor may occur as the PWM control stops. Therefore, it is possible to minimize the speed and output fluctuation of the descending motor during switching by minimizing the PWM control time according to improve the relay switching speed.

A motor driving apparatus 400 according to an embodiment of the present invention, and an air conditioner including the same, includes switching elements Sa, Sa′, Sb, Sb′, Sc, Sc′. And the motor driving apparatus 400 includes an inverter 420 that outputs AC power to a motor 250, and a relay 700, and a switching unit 440 configured to switch the connection mode of the motor 250 by the operation of the relay 700.

In addition, the motor driving apparatus 400 and an air conditioner including the same according to an embodiment of the present invention may include an inverter controller 430 configured to control the inverter 420 and the switching unit 440. According to an embodiment, a home appliance such as an air conditioner or a motor driving apparatus may include a separate controller (not shown) for controlling switching of a connection mode. Hereinafter, an embodiment in which the inverter controller 430 controls the relay 700 of the switching unit 440 to switch the connection mode is described, but a separate controller configured to control the switching of the connection mode in the same manner able to control the relay 700. Meanwhile, the inverter controller 430 may apply a negative (−) reverse voltage when the relay 700 is turned off.

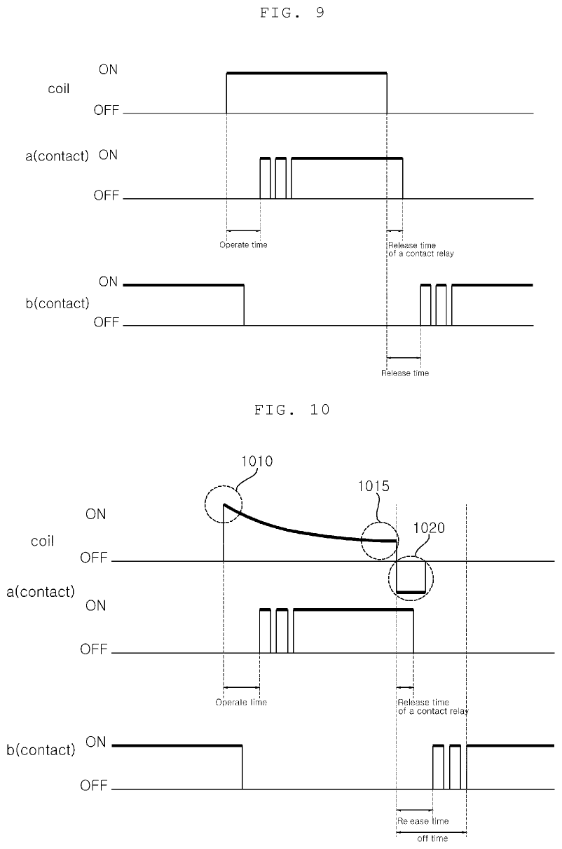

FIG. 10 is a diagram illustrating a relay operation waveform according to an embodiment of the present disclosure.

Referring to FIG. 10, the inverter controller 430 may apply a negative (−) reverse voltage 1020 to the coil Lr of the relay 700 when the relay 700 is turned off.

In the relay 700 according to an embodiment of the present invention, when the coil voltage is turned on, the contact state may be set to the contact a, and when the coil voltage is off, the contact state may be set to the contact b.

When the coil voltage of the relay 700 is turned on, the coil Lr is magnetized and moves to the contact a by electromagnet force, and when the coil voltage is off, the coil may move to the contact b by spring force.

The on/off time of the relay 700 varies depending on the coil voltage. For example, the operating time is an on time excluding chattering in which opening and closing are repeated when the state of the switching changes, and the higher the voltage, the faster it is. In addition, the release time is an off time excluding chattering, and the lower the voltage is, the faster it is.

When a negative (−) reverse voltage 1020 is applied when the relay 700 is turned off, the magnetization of the coil Lr may be quickly removed and current may be quickly lost. Accordingly, the contact of the relay 700 may move faster with a spring force.

Accordingly, when the relay 700 is turned off, a negative (−) reverse voltage 1020 is applied to reduce the return time and the relay operation time.

Here, the section in which the negative (−) reverse voltage 1020 is applied may be set to be shorter than the total off time of the relay. Accordingly, it is possible to prevent an increase in chattering when the relay 700 is turned off.

Meanwhile, when the relay 700 is turned on, a positive (+) high voltage is applied to the coil Lr, so that the operation time may be reduced. In addition, power consumption of the coil Lr may be reduced by maintaining a low voltage after the relay 700 is turned on.

That is, the inverter controller 430 may reduce power consumption by controlling the sustain voltage 1015 after the on point of the relay 700 to be lower than the on voltage 1010 at the on point of the relay.

According to an embodiment of the present invention, when implementing the switching algorithm, it is possible to minimize a decrease in a motor operation frequency caused by the delay time by minimizing the switching delay time.

The relay contact movement characteristics may be divided into the following three sections.

1) Maintenance section: the previous state may be maintained and the existing control method may be maintained.

2) Moving section: separated from the existing a contact point moved to the opposite contact point

3) Bouncing section: from the first moving point of the opposite contact to the end of bouncing

Due to the characteristics of the relay, electrical and mechanical delays of about tens of ms occur from the point when the relay signal changes to the point where the bouncing section ends. Immediately before switching the relay signal, the previous winding type sensorless algorithm (PWM) is stopped, and when bouncing is completed, a sensorless algorithm suitable for the characteristics of the switched motor is started.

At this time, the switching delay time may be further shortened by additionally proceeding with the sensorless algorithm of the previous winding type in the maintenance section at the previous contact point.

According to an embodiment of the present invention, when a continuous winding switching technique of an inverter/motor using a sensorless control technique is used, a delay time of a relay that occurs may be reduced. In addition, due to the reduction in the delay time, it is possible to minimize the motor output fluctuation, thereby minimizing the motor speed reduction during switching.

In addition, since the longer the delay time, the longer it takes to switch, and thus, it is possible to reduce control instability in the PWM control stop section by reducing the delay time.

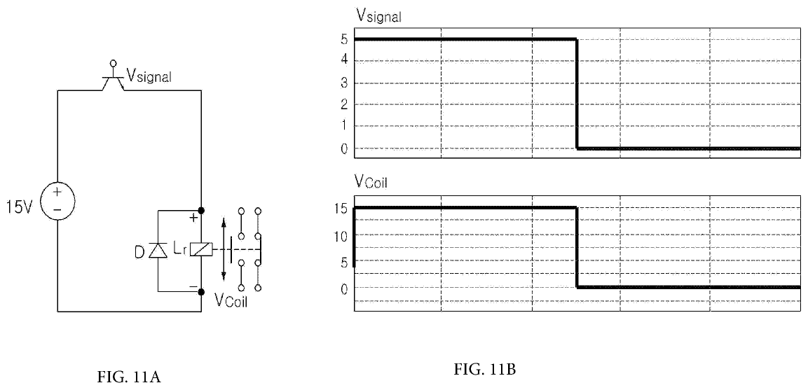

FIG. 11 is a diagram illustrating an example of a conventional relay circuit and an operation waveform.

Referring to FIG. 11A, the existing relay circuit may include a coil Lr that is magnetized according to power supply, a diode (D) connected to both ends of the coil Lr to prevent reverse current, and a signal switch (SW) to supply or cut off power to the coil Lr.

Referring to FIG. 11B, when the switching signal Vsignal is high, the signal switch SW is turned on. Accordingly, since all of the input power 15V is applied to the coil Lr, the coil voltage V_Coil becomes 15V, and the relay is turned on according to the magnetization of the coil Lr.

In addition, when the switching signal Vsignal is low, the signal switch SW is turned off, the coil voltage V_Coil becomes 0V, and the relay is turned off.

Referring to FIG. 11B, the voltage for turning on the relay is 15V, and the sustain voltage until the relay is turned off is also the same as 15V.

However, according to an embodiment of the present invention, when the relay 700 is turned on, a positive (+) high voltage 1010 is applied to the coil Lr to quickly turn on the relay. By controlling the sustain voltage 1015 to be lower than the on voltage 1010 at the on-time of the relay, power consumption may be reduced.

In addition, according to an embodiment of the present invention, when the relay 700 is off, a negative (−) reverse voltage may be applied to perform the off operation more quickly.

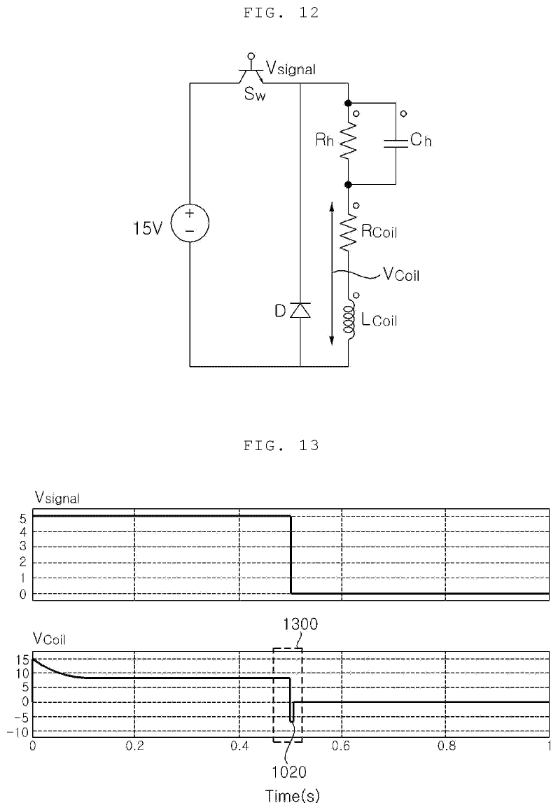

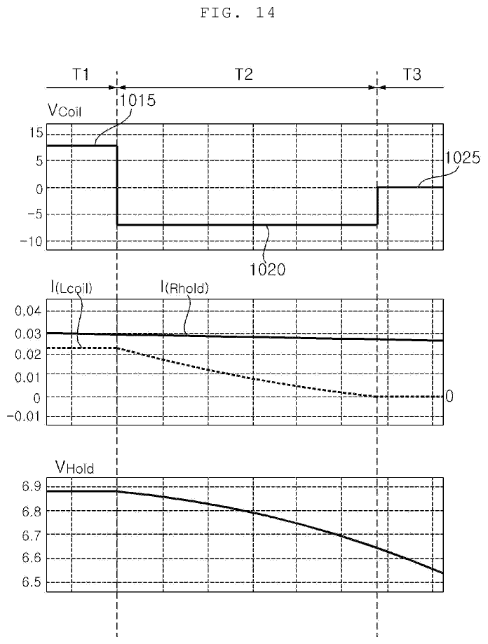

FIG. 12 is a diagram illustrating an example of a relay circuit according to an embodiment of the present disclosure, and FIG. 13 is a diagram illustrating an example of an operation waveform of a relay circuit according to an embodiment of the present disclosure.

Referring to FIG. 12, the relay according to an embodiment of the present invention may include a coil Lr configured to magnetize according to power supply, a holding resistor Rh connected in parallel to the coil Lr, and a holding capacitor Ch, and a diode D configured to have one end connected to the coil Lr, and the other end connected to the holding resistor Rh and the holding capacitor Ch.

In addition, the relay according to an embodiment of the present invention may further include a signal switch SW connected to the other end of the diode D to supply or cut off power to the coil Lr.

Referring to FIGS. 12 and 13, when the switching signal Vsignal is high, the signal switch SW is turned on. Accordingly, since all of the input power (eg, 15V) is applied to the coil Lr, the coil voltage V_Coil becomes 15V, and the relay is turned on according to the magnetization of the coil Lr.

Thereafter, the coil voltage V_Coil may be reduced from the ON voltage (eg, 15V) to maintain the voltage 1015 lower than the ON voltage.

Meanwhile, when the relay 700 is turned off, a negative (−) reverse voltage 1020 may be applied to perform the off operation more quickly.

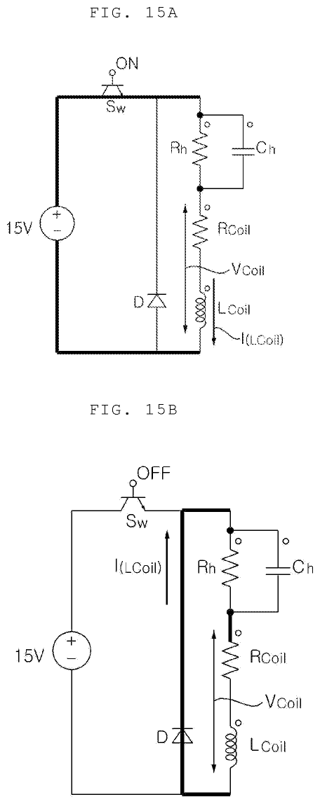

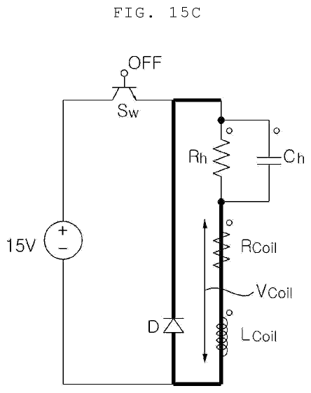

FIG. 14 is an enlarged view illustrating a part 1300 of an operation waveform of FIG. 13 and FIGS. 15a to 15c are diagrams illustrating current paths corresponding to the operation waveform section of FIG. 14. In FIGS. 15A to 15C, the coil Lr is divided into a resistance component R_Coil and an inductance component L_Coil and displayed.

Referring to FIGS. 12 to 15A, the on voltage is reduced by the holding voltage V_Hold of the holding resistor Rh and the holding capacitor Ch in the applied voltage. Here, the holding voltage may be based on the holding resistor Rh of the R_Hold and C_Hold values of the holding capacitor Ch. The holding voltage 1015 before OFF decreases at a ratio of the coil resistance R_Coil and the holding resistance Rh. At this time, when the voltage of the holding capacitor Ch is all charged, the coil resistance R_Coil and the holding resistance Rh are shown in series, and thus coil power consumption may be reduced.

In addition, the signal switch SW is maintained in the ON state and a constant current I (L_Coil) flows through the coil Lr. in the first period T1 in which the sustain voltage 1015 is applied before the off.

Referring to FIGS. 14 and 15B, the diode D is conducted in the coil Lr according to the off of the signal switch SW and a coil current I(L_Coil) flows through the diode D in the second period T2 in which the reverse voltage 1020 is applied. Accordingly, a reverse voltage corresponding to the holding voltage V_Hold of the holding resistor Rh and the holding capacitor Ch is applied to the coil Lr.

The inverter controller 430 may control the reverse voltage 1020 to be applied to the coil Lr for a predetermined time by turning off the signal switch SW while a predetermined current flows through the coil Lr.

When the signal switch SW is turned off, the diode D is conducted and flows a coil current I (L_Coil). The coil voltage V_Coil becomes a negative (−) reverse voltage. On the other hand, since there is no additional power supply, the coil current I(L_Coil) decreases as the signal switch SW is turned off.

Referring to FIGS. 14 and 15C, as the coil current I(L_Coil) which has been decreased becomes 0, the diode D is turned off, and the reverse voltage application is terminated. Accordingly, the coil voltage V_Coil in the third period T3 becomes 0.

According to an embodiment of the present invention, a reverse voltage is applied when the relay is turned off to quickly remove the magnetization of the coil and shorten the off time.

According to an embodiment of the present invention, in a motor operating through a sensorless algorithm, a control time for switching a motor winding to be driven may be reduced by using a time when an excited coil of a relay is extinguished.

On the other hand, the second section T2 is an operation for removing the relay magnetization of the contact, and it is desirable to design the second section T2 faster than the relay off time as a reverse voltage application time.

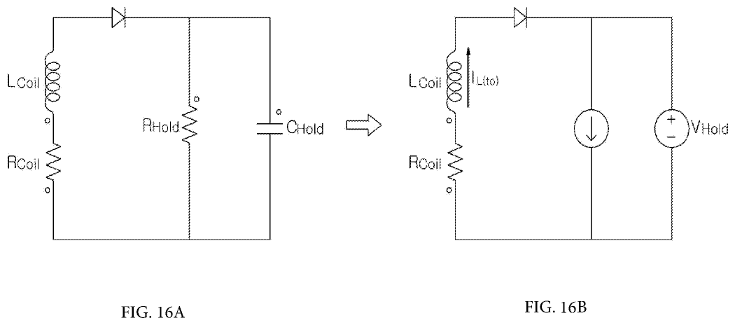

FIG. 16 is a diagram illustrating a relay circuit current path and an equivalent circuit in a reverse voltage section according to an embodiment of the present disclosure.

The FIG. 16A illustrates only the current path after removing the power and the off signal switch SW in the circuit of FIG. 15B.

On the other hand, if the C_Hold value is large enough, it may be simplified as a voltage source, and R_Hold may be simplified as a current source.

Accordingly, FIG. 16A may be simplified as shown in FIG. 16B.

The reverse voltage application time (Δt) may be obtained according to the power series RL current equation of Equations 3 and 4 below.

$$\begin{matrix}{i}_{L} ( t ) = \frac{{V}_{Hold}}{{R}_{Coil}} + ( {i}_{L ( t 0 )} - \frac{{V}_{Hold}}{{R}_{Coil}} ) \cdot {e}^{\frac{{R}_{Coil}}{{L}_{Coil}} \cdot ( t - t 0 )} & [ Equation 3 ] \\ {i}_{L} ( t ) = 0 , Δ t = - \frac{{L}_{Coil}}{{R}_{Coil}} \cdot ln ( - \frac{{V}_{Hold}}{{R}_{Coil} \cdot ( {i}_{L ( t 0 )} - \frac{{V}_{Hold}}{{R}_{Coil}} )} ) & [ Equation 4 ]\end{matrix}$$

Meanwhile, the inverter controller 430 stops the PWM (Pulse Width Modulation) control according to the switching of the connection mode, estimates the rotational state of the rotor rotating inertia. When the PWM control resumes, the inverter controller 430 may be set the estimated rotational state as the initial value of the rotor, and control the rotation speed of the motor in which the connection mode is switched based on the set initial value of the rotor.

The inverter controller 430 may perform switching of the connection mode. Accordingly, the output of the inverter 420 and the motor torque may be blocked. Accordingly, the rotor of the motor 250 may be in an inertial rotational state, and the rotation speed of the rotor may decrease due to a gradually decreasing moment of inertia.

Meanwhile, the inverter controller 430 may estimate the rotational state of the rotor in inertia rotation during the time when the output of the inverter 420 and the motor torque are cut off by the switching, that is, the time when the PWM control is stopped. For example, the estimated rotational state may include a rotation speed of the rotor and a position of the rotor (position of the N pole).

In addition, when the switching is completed, the output of the inverter 420 and the motor torque are again applied to the motor 250. If the output of the inverter 420 and the motor torque are again applied to the motor 250, the inverter controller 430 may set the initial value of the rotor according to the estimated rotational state. Further, the inverter controller 430 may control the rotation of the motor 250 in which the connection mode is switched, that is, the rotation of the rotor of the motor 250 based on the set initial value. In this case, the inverter controller 430 may correct the position of the rotor according to the phase difference (30 degrees) according to the switching of the connection mode.

Meanwhile, when driving according to the switched connection mode is started, the inverter controller 430 may perform a motor control for stabilization of restarting for a predetermined time. The restart stabilization control period may be a period in which a rotation speed according to an initial value of the currently set motor 250 is maintained. And when the restart stabilization control period is completed, the rotor is accelerated based on the initial speed of the rotor until the speed of the rotor reaches the speed according to the speed of the changed speed command frequency (When switching from Y connection mode to A connection mode) or deceleration (When switching from Δ connection mode to Y connection mode). Further, when the rotation speed of the rotor reaches the rotation speed according to the changed speed command frequency, that is, the target rotation speed, the current motor control state may be maintained.

Meanwhile, when the compressor is driven by the motor 250, the pressure of the compressor is lost only during the time when the rotation speed of the rotor decreases from the rotation speed before switching to the initial speed of the rotor by setting the initial speed of the rotor based on the rotational state of the rotor rotating inertia. Therefore, it is possible to minimize the loss of the compressor pressure caused by switching the motor connection mode.

Also, the rotor may be accelerated or decelerated only from the initial speed of the rotor to the target rotation speed. Therefore, the time for the rotation speed of the motor (rotor) to reach the target rotation speed may be shortened, and thus the waste of power may be prevented.

The motor driving apparatus and the home appliance having the same according to an embodiment of the present disclosure are not limited to the configuration and method of the embodiments described above, but the above embodiments may be configured by selectively combining all or part of each of the embodiments so that various modifications can be achieved.

Meanwhile, the operation method of the motor driving apparatus or air conditioner according to the present invention can be realized as code, which can be written on a recording medium that can be read by a processor equipped in the motor driving apparatus or air conditioner and can be read by a processor. The recording medium that can be read by a processor includes all kinds of recording media, on which data that can be read by a processor is written. The recording medium that can be read by a processor can be distributed to computer systems connected to one another on a network, and codes that can be read by a processor can be stored in the recording medium in a distributed manner and executed.

In addition to variations and modifications in the component parts and/or arrangements, alternative uses will also be apparent to those skilled in the art.

According to at least one of the embodiments of the present disclosure, it is possible to provide a motor driving apparatus capable of switching the connection mode of a motor at high speed, and air conditioner including the same.

In addition, according to at least one of the embodiments of the present disclosure, it is possible to provide a motor driving apparatus capable of preventing a decrease in efficiency due to switching of a connection mode, and air conditioner including the same.

In addition, according to at least one of the embodiments of the present disclosure, it is possible to provide a motor driving apparatus capable of minimizing output fluctuations of a motor by minimizing the speed that decreases during switching by reducing delay time of a relay, and air conditioner including the same.

In addition, according to at least one of the embodiments of the present disclosure, it is possible to provide a motor driving apparatus capable of reducing power consumption when switching a connection mode, and air conditioner including the same.

What is claimed is:

1. A motor driving apparatus comprising:
an inverter that includes a plurality of switching elements and that is configured to output AC power to a motor by a switching operation of the plurality of switching elements;
a switching unit that includes a relay and that is configured to switch a connection mode of the motor by an operation of the relay; and
an inverter controller configured to control the inverter and the switching unit,
wherein the inverter controller is configured to, based on the relay being turned off, apply a reverse voltage to the relay.

2. The motor driving apparatus of claim 1, wherein the inverter controller is configured to control a sustain voltage, which is applied to the relay after the relay is turned on, to be lower than a relay voltage corresponding to voltage when the relay is turned on.

3. The motor driving apparatus of claim 1, wherein the relay includes:
a coil configured to be magnetized by receiving current from a power supply,
a holding resistor and a holding capacitor connected in parallel to the coil, and
a diode having a first end connected to the coil and a second end connected to the holding resistor and the holding capacitor.

4. The motor driving apparatus of claim 3, wherein the relay further includes a signal switch connected to the second end of the diode and configured to selectively supply or cut off power to the coil.

5. The motor driving apparatus of claim 4, wherein the signal switch is configured to, based on the signal switch being turned on, supply constant current to the coil, and
wherein the signal switch is configured to, based on the signal switch being turned off, enable a coil current to flow from the coil to the diode.

6. The motor driving apparatus of claim 5, wherein the diode is configured to be turned off based on the coil current being decreased to zero.

7. The motor driving apparatus of claim 5, wherein the inverter controller is configured to, based on a predetermined current flowing through the coil, (i) turn off the signal switch and (ii) apply the reverse voltage to the coil for a predetermined time.

8. The motor driving apparatus of claim 7, wherein the inverter controller is configured to control a first time period for applying the reverse voltage to be shorter than a second time period for the relay being turned off.

9. The motor driving apparatus of claim 1,
wherein a coil of the relay is configured to, based on a coil voltage being applied to the coil of the relay, move to contact a first contact point of the relay, and
wherein the coil of the relay is configured to, based on the coil voltage not being applied to the coil of the relay, move to contact a second contact point of the relay.

10. The motor driving apparatus of claim 1, wherein the plurality of switching elements and the relay are arranged at different printed circuit boards.

11. The motor driving apparatus of claim 1, wherein the inverter controller is configured to:
stop a Pulse Width Modulation (PWM) control according to the switching of the connection mode,
estimate a rotational state of a rotor rotating inertia, the rotor included in the motor,
set, based on the PWM control resuming, the estimated rotational state of the rotor as an initial value of the rotor, and
control a rotation speed of the motor in which the connection mode is switched based on the initial value of the rotor.

12. A motor driving apparatus comprising:
an inverter that includes a plurality of switching elements and that is configured to output AC power to a motor by a switching operation of the plurality of switching elements; and
a switching unit that includes a relay and that is configured to switch a connection mode of the motor by an operation of the relay; and
wherein the relay includes:
a coil configured to be magnetized by receiving current from a power supply,
a holding resistor and a holding capacitor connected in parallel to the coil, and
a diode having a first end connected to the coil and a second end connected to the holding resistor and the holding capacitor.

13. The motor driving apparatus of claim 12, wherein the relay further includes a signal switch connected to the second end of the diode and configured to supply or cut off power to the coil.

14. The motor driving apparatus of claim 13,
wherein the signal switch is configured to, based on the signal switch being turned on, supply constant current to the coil, and
wherein the signal switch is configured to, based on the signal switch being turned off, enable coil current to flow from the coil to the diode to conduct the diode.

15. The motor driving apparatus of claim 14, wherein the diode is configured to be turned off based on the coil current being decreased to zero.

16. The motor driving apparatus of claim 12, wherein the coil is configured to, based on a coil voltage being applied to the coil, move to contact a first contact point of the relay, and
wherein the coil is configured to, based on the coil voltage not being applied to the coil, move to contact a second contact point of the relay.

17. The motor driving apparatus of claim 12, wherein the plurality of switching elements and the relay are arranged at different printed circuit boards.

18. The motor driving apparatus of claim 12, further comprising a controller configured to control the switching unit.

19. The motor driving apparatus of claim 12, further comprising an inverter controller configured to control the inverter and the switching unit.

20. An air conditioner comprising:
an inverter that includes a plurality of switching elements and that is configured to output AC power to a motor by a switching operation of the plurality of switching elements; and
a switching unit that includes a relay and that is configured to switch a connection mode of the motor by an operation of the relay; and
wherein the relay includes:
a coil configured to be magnetized by receiving current from a power supply,
a holding resistor and a holding capacitor connected in parallel to the coil, and
a diode having a first end connected to the coil and a second end connected to the holding resistor and the holding capacitor.
